(19) United States
(12) Patent Application Publication
(10) Pub. No.: US 2009/0009329 A1
(43) Pub. Date: Jan. 8, 2009

(54) Antitheft security sticker for mobile electronic devices

(76) Inventors: Babatunde Olakunle Edun, Surulere (NG); Simon Olanrewaju Adeoye, Victoria Island (NG); Joel Akinfemi Akinware, Victoria Island (NG)

Correspondence Address: TRIANGLE PATENTS, P.L.L.C., P.O. BOX 28539, RALEIGH, NC, 27611-8539, US

(21) Appl. No.: 11/824,697

(22) Filed: Jul. 2, 2007

(51) Int. Cl. G08B 13/12

(52) U.S. Cl. 340/568.4

(57) ABSTRACT

An anti-theft security sticker with power control circuitry adhesively connectable or connected to a surface of a mobile electronic device and in electronic connection to the power supply of the device. After the anti-theft security sticker is affixed to the device, tampering or removing it disables the device by preventing power supply to it.

### BACKGROUND OF THE INVENTION

1. Field of the Invention

The present invention relates generally to security for mobile electronic devices, and more particularly to an anti-theft product that is attached to a mobile electronic device for rendering it inoperable under predetermined conditions.

2. Description of the Prior Art

Theft of mobile electronic devices and equipment is a significant economic problem, estimated to be millions of dollars annually in the cost of hardware replacement alone. In 2003, for example, more than 600,000 laptop computers were reported stolen, estimated at more than $720MM in hardware replacement costs and more than $5.4B in theft of proprietary information, according to Safeware Insurance statistics. Also, according to a US FBI report, 97% of stolen laptop computers were never recovered. These figures continue to increase, due to lack of adequate preventive, deterrent, or corrective measures. These numbers also do not consider other mobile electronic devices that are at least as prevalent as laptop computers, such as mobile phones, personal digital assistants (PDAs), digital cameras and video equipment, MP3 players, electronic game devices, camcorders, portable gaming devices, GPS equipment, portable DVD players and other portable audio devices (radios, CD players etc.) and the like. Thus there is a significant economic problem associated with mobile or portable electronic devices being stolen and not recovered.

While most of these mobile electronic devices include some type of security features, such as password protection, fingerprint or other biometric identification and access restriction, personal identification number (PIN) codes, and the like and combinations thereof, these security features have generally included software-based solutions; in any case, these are inadequate for preventing theft and reuse or resale of the equipment by unauthorized users who are not the rightful owners. Thus, existing security features do not prevent or deter theft of the mobile electronic devices because their theft still provides for beneficial use of the device, i.e., the device is not rendered inoperable following the theft.

In any case, research shows that the theft of the mobile electronic devices is most generally connected with beneficial use of the hardware, not the software or data stored thereon. Typically, stolen mobile electronic equipment is sold on the black market for about 20% of the equipment value, which also supports the fact that there is no additional value to the data or intangible property associated with the devices. However, to the rightful owner of the mobile electronic device, the data, information, software or other intangible property associated with the device is generally much more valuable than the hardware itself, which is more readily replaceable. Again, software-based solutions of the prior art do not provide adequate protection for the hardware to prevent theft or increase the likelihood of recovery; they have an inherent weakness of being readily subject to being erased, reprogrammed, or simply by-passed. Thus, there remains a need for a mobile security means that provides a theft deterrence or prevention, but also provides for device recovery if a theft occurs.

An example of prior art includes US Patent Application No. 2007/0030149 entitled “Theft Deterrence System for a Portable Computer and Method” that discloses a controller inside the computer that uses logic circuitry, software, and/or firmware to disable the hard drive of the computer upon start-up when an external security device has been removed.

By contrast to the prior art, the present invention provides a mobile security embedded sticker (MAES) that renders a mobile electronic device inoperable by disabling the power supply (and thereby preventing computer start-up, which provides increased protection to the computer hardware and software because the entire system is inoperable) if stolen and also provides for identification of the rightful owner and protection of the data to ensure its recovery upon return. Preferably, the present invention is integratable with existing mobile devices and technologies for security to enhance current protections and improve likelihood of data and hardware recovery if stolen, at least inasmuch as the identification of the owner is provided as one aspect of the present invention, in connection with the theft-deterrence functionality and embodiments. In a preferred embodiment, the invention functions to prevent and discourage theft by rendering the hardware useless and valueless to the thief. If a would-be thief realizes that the hardware he intends to steal will not yield any economic advantage, the lure of the crime is at once removed.

### SUMMARY OF THE INVENTION

A first aspect of the present invention is to provide an antitheft sticker for securing mobile electronic devices and equipment including a substrate having circuitry for controlling power supplied to a portable electronic device wherein the substrate further includes an adhesive applied to a back side for attachment to a surface of the device and the face side includes the circuitry, which is wired onto a micro printed circuit board and then embedded into a groove etched on the face side; wherein the substrate is affixed to a surface of the device and the power control circuitry connected thereto such that the tampering, damaging, or removal of the sticker and/or its embedded circuitry deactivates the power control circuitry so that the device is disabled without authorized user or supplier intervention.

A second aspect of the present invention is to provide a mobile electronic device or equipment having anti-theft features provided by a sticker having power control circuitry for deactivating the power to the device if the sticker is removed therefrom. The external/front side of the sticker features the identity of the owner of the device and may also provide a warning to would-be thieves that the hardware is so protected. The name/identity of the owner is printed on the sticker at the point of purchase.

The present invention is further directed to a method for securing mobile electronic devices and equipment including the steps of providing a substrate having circuitry for controlling power supplied to a portable electronic device wherein the substrate further includes an adhesive applied to a back side for attachment to a surface of the device and the face side includes the circuitry, which is wired onto a micro printed circuit board and then embedded into a groove etched on the face side; and affixing the substrate to the device, wherein removal of the substrate deactivates the power control circuitry so that the device is disabled without authorized user or supplier intervention. The reason an unauthorized individual would remove the sticker is because it identifies the lawful owner of the device and a thief would seek to remove this identification.

Thus, the present invention provides a low-cost anti-theft device for mobile electronic devices and computers that ensures device protection by deactivating the power supplied to the device if stolen, while providing identification of the authorized owner and/or user of the device or equipment.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is an illustration of the face side of the sticker according to one embodiment of the present invention.

FIG. 2 is a block diagram for circuitry associated with an embodiment of the present invention.

FIG. 3a illustrates a typical configuration for the circuitry shown in FIG. 2.

FIG. 3b shows the configuration of FIG. 3a covered with an epoxy and prepared for application to the board.

FIG. 4a shows the substrate of the sticker shown in FIGS. 1-3.

FIG. 4b shows the substrate and internal groove etching on FIG. 4a.

FIG. 5 illustrates the security devices of the FIGS. 1-4 applied to a mobile electronic device.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides an anti-theft security sticker including a substrate with embedded power control circuitry that is affixable or affixed to a surface of a mobile electronic device and constructed and configured in electronic connection to the power supply of the device wherein tampering, damaging, or removing the sticker disables the device by preventing power supply to it.

The mobile anti-theft security sticker of the present invention is designed, constructed, and configured to deactivate or disable operation of the mobile electronic device by preventing power supply thereto if the sticker circuitry is tampered with, damaged, or disabled. It also provides for identification and contact information of the owner to improve likelihood of return and recovery of the data and intangible property on the device, even if the device has been disabled by an unauthorized user or person other than the owner or an authorized service provider or retailer.

Preferably, the power control circuitry provided on the substrate of the security sticker of the present invention replaces or overrides the power control circuitry on the main board of the mobile electronic device. Therefore, disabling or removing the security sticker disables the power supply of the device, thereby rendering it inoperable.

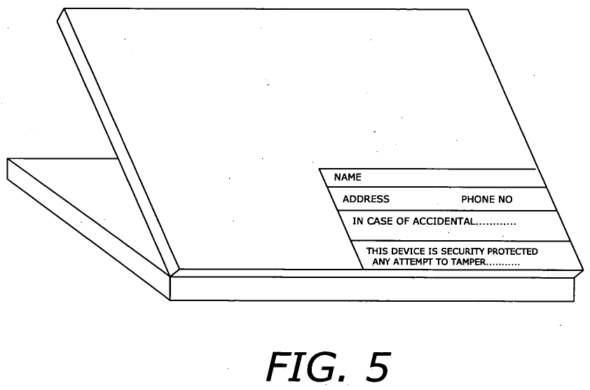

Referring now to the drawings in general, the illustrations are for the purpose of describing a preferred embodiment of the invention and are not intended to limit the invention thereto. As best seen in FIG. 5, in a preferred embodiment of the present invention, the anti-theft security sticker with power control circuitry is adhered to a surface of the mobile electronic device and in electronic connection to the power supply of the device. After the anti-theft security sticker is affixed to the device, tampering or removing it disables the device by preventing power supply to it.

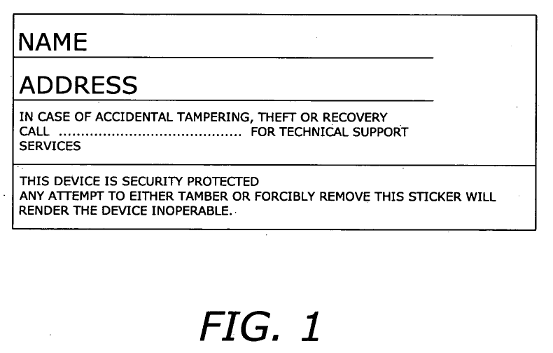

As illustrated in FIG. 5 and also shown in FIG. 1, the face side of the sticker according to one embodiment of the present invention includes identification and indicia related to the ownership of the device, including name and address or location, telephone or other contact-related information, and an alert message, warning or other notification that the device includes a security feature that renders the device inoperable. Preferably, the warning or notification further includes an indication that the sticker itself includes anti-theft properties or features, particularly indicating that any attempt to remove or tamper with the sticker will disable the system and prevent its functioning. Also preferably, a support service message is also provided so that there is notification in the event of accidental damage or tampering, or for the purpose of legal transfer of ownership, which would require removing, changing or officially altering the sticker. It also serves for notification or to report theft or recovery of the device if stolen. Also, space is provided for the legal owner to inscribe with indelible ink, some contact, identification or location information. Other identification or information may be included thereon, such as vendor codes, bar codes, and the like. For example, a bar code is illustrated in FIG. 1 at the lower left corner of the face side of the sticker. Importantly, this bar code tallies with another code on the system's main board.

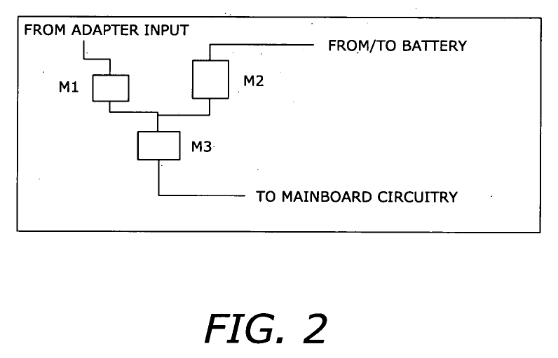

FIG. 2 is a block diagram for circuitry associated with an embodiment of the present invention. It illustrates a typical block diagram of power distribution in mobile devices. M1, M2, M3 represent switching devices that may be used singularly or in parallel. In one embodiment shown, M1 is connected to leads from an adapter input; M2 includes leads from and to a battery; M3 is connected to M1, M2, and leads to a mainboard circuitry. The block diagram of FIG. 2 provides a pattern of voltage distribution to the system board of the mobile electronic device or equipment, from the input from the A/C-D/C adapter to the process of charging batteries, and to supplying the board with power, and taking voltage back from the batteries during back-up power usage. M1, M2, M3 shown are power switching devices, such as MOSFETs or other switching devices. The specific selection of switching device type depends upon the electronic device or equipment itself, and the preferences or selections of the manufacturer of the device. M1, M2, M3 can be a single switching device or multiple devices connected in parallel to handle higher currents. Preferably, the basic configuration illustrated in FIG. 2 is operable and functional for any type of mobile electronic device to which the security sticker is applied.

In some mobile devices, the entire configuration for the circuitry could be achieved in a single device. While the block diagram illustrates one embodiment of the present invention, it is not intended to limit the invention thereto; rather, all power configurations are intended to be considered within the scope of the present invention. By way of example and not limitation, another embodiment includes a single wire fuse embedded in the sticker of the present invention wherein the device is disabled if tampering with the sticker (and therefore disruption or damage to the single wire fuse within the sticker) occurs.

Once again, the design of the security power control circuitry of the sticker of the present invention as set forth in FIG. 2 is intended to replace that section that is typically on the main system board; it is instead wired onto a separate micro printed circuit board and then embedded into a groove etched onto the face side surface of the substrate of the sticker.

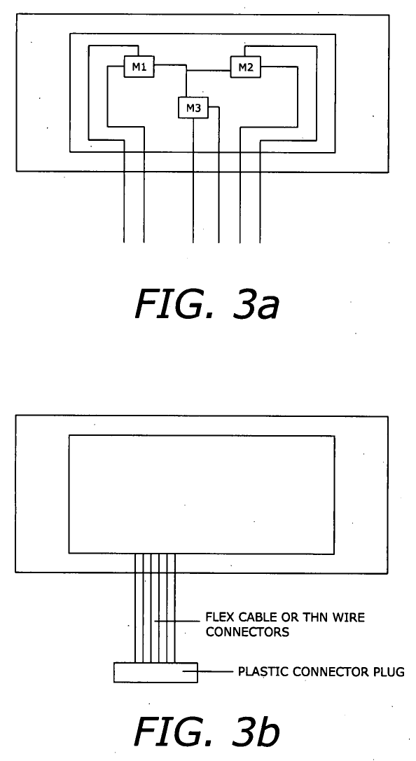

FIG. 3a illustrates a typical configuration for the circuitry shown in FIG. 2. This circuitry is preferably constructed and configured on the inside of the sticker, i.e., it is not presented directly on a face side of the sticker, but is covered or shielded from the face side or exposed surface. In a preferred embodiment of the present invention as illustrated in FIG. 3a, a MQSFET bank is provided as employed in the computer device to which the sticker is attached. For devices that produce heat during operation, it is preferable to include a heat absorbing material mounted on the device to ensure proper operation of the circuitry without damage do to heat produced by the device during operation.

FIG. 3b shows the configuration of FIG. 3a covered with an epoxy and prepared for application to the board, with the wires drawn out of the circuitry and connected with a plug, such as a plastic connector plug, fixed for mounting on the board of the device. The wires are flex cables or thin wire connectors.

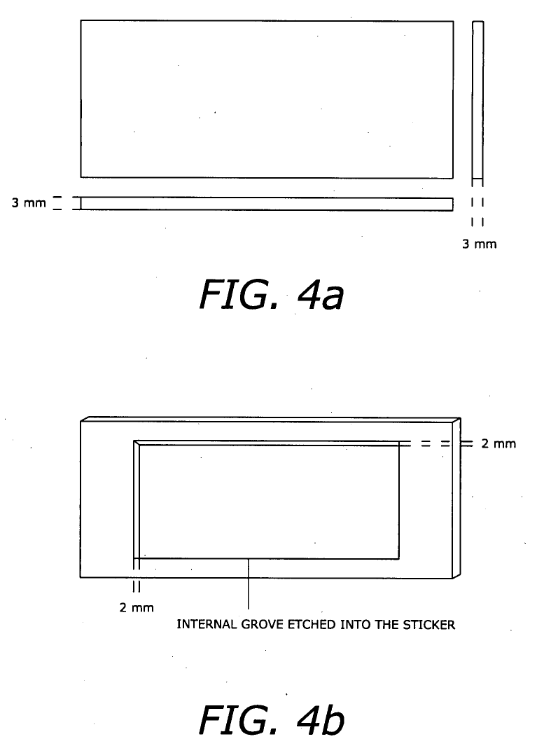

FIG. 4a shows the substrate of the sticker shown in FIGS. 1-3. FIG. 4b shows the substrate and internal groove etching on FIG. 4a. In particular, FIGS. 4a and 4b are provided to illustrate preferred embodiment dimensions, including the sticker and substrate thickness between about 1 mm and about 5 mm, preferably totaling about 3 mm. In The internal groove etched in the substrate is preferably between about 0.5 mm and about 2.5 mm, preferably about 2 mm. These preferred dimensions provide a depth of groove for fully embedding the micro printed circuit board (PCB) including the power switches into the substrate. Additionally, these dimensions provide adequate depth for inscribing or etching names or other indicia on the substrate and sticker. The depth of the groove being preferably about 2 mm is optimal for embedding the power switch assembly on the printed circuit board full without exposure. The PCB with the power switch assembly is then embedded in the groove and the different pins, i.e., input pins, output pins, and control pins, are led out using flexible tamperproof wires with a plug connected to the tail ends (shown in FIG. 3a) operable for connection to the main system board.

To protect the identity of the components embedded inside the groove, a thick black substance of an insoluble material, such as an epoxy, is applied to the groove to cover the circuitry, as illustrated in FIG. 3b. This material also provides a delimiting point for the wires to determine breakage point(s) in case of forced removal.

FIG. 5 illustrates the security devices of the FIGS. 1-4 applied to a mobile electronic device, namely, by way of example and not limitation, a portable laptop computer wherein the anti-theft sticker including power control circuitry is applied to an external surface of the computer body or housing proximal the power inputs. The sticker is preferably attached to the device with adhesive that is applied to the back side of the substrate/sticker. While it may be positioned in any location on a surface of the device, an outside, conspicuous location expectedly provides the best deterrence to theft, since the face side of the sticker has warning notices, as set forth hereinabove. A small opening in the case provides a passage for the wires from the power control circuitry. The wires immediately inside the case are woven deep into the case to ensure a tightness that provides no leverage between the sticker and the case. The wire ends are further connected to a plug for removable connection to the board, thereby providing completely functioning and operable circuitry to ensure power supply via the power switches in the power control circuitry so that the mobile electronic device is operable once the sticker is installed and its wiring is connected to the main board. In the event of disruption, damage or tampering with the sticker and its corresponding power control circuitry, the power supply to the device is disabled until the legal owner or his authorized service personnel are able to restore the system to a working state by repairing or replacing the wiring in the sticker, which requires access code(s) in addition to other security means. Repair codes are provided only to authorized resellers of the mobile devices. These authorized dealers also provide owner inscription at the point of purchase. In the event where the sticker is mistakenly damaged, the authorized reseller is able to replace the sticker using machinery provided exclusively by the manufacturer. Also, the architecture of the chipset and the power circuitry are kept secret in order to prevent their manipulation, deactivation, or by-passing. Also, the machinery for inscribing, replacing and repairing damaged stickers and power circuitry are distributed only to authorized OEM resellers, which improves the overall awareness about the devices and their credibility as to the legal owner's name incription. As an added advantage, consumers will henceforth find it more attractive to buy devices from authorized OEM resellers rather than the open, gray or black market.

While a laptop computer is shown in FIG. 5, any portable or mobile electronic device or equipment having a power supply or requiring power input is considered within the scope of the present invention; by way of example and not limitation, this includes notebook computers, personal digital assistant devices (PDAs), sub-notebooks, mobile phones, digital cameras, MP3 players, portable game devices, and the like, and combinations thereof.

Certain modifications and improvements will occur to those skilled in the art upon a reading of the foregoing description. By way of example, one may attempt to disable the HDD of a laptop computer instead of its power circuitry; or one may seek to disable the re-charging circuitry of a laptop or mobile phone in lieu of its power circuitry. These are obvious modifications. The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. An antitheft sticker for securing mobile electronic devices and equipment comprising:
a. substrate having circuitry for controlling power supplied to a portable electronic device, the substrate having a face side and a back side;
an adhesive applied to the back side of the substrate for attachment to a surface of the portable electronic device;
the circuitry being wired onto a microprinted circuit board and embedded into a groove etched on the face side of the substrate and connectable to the portable electronic device for controlling the power supply thereto, wherein tampering or damaging the circuitry disables the device,
thereby providing increased security via theft deterrence.

2. The sticker of claim 1, further including an epoxy covering the circuitry.

3. The sticker of claim 1, wherein the circuitry further includes power switching devices.

4. The sticker of claim 1, wherein the circuitry is connected to the power supply of the mobile electronic device.

5. The sticker of claim 1, wherein the circuitry replaces power control circuitry on the main board of the device.

6. The sticker of claim 1, wherein the circuitry is a single wire.

7. The sticker of claim 1, wherein the front side of the sticker further provides for an inscription for identifying the legal owner and other information.

8. A mobile electronic device comprising antitheft features provided by a sticker having power control circuitry for deactivating the power to the device if the sticker is removed therefrom or tampered with.

9. The device of claim 8, wherein the power control circuitry is embedded in a groove etched in a substrate of the sticker.

10. The device of claim 8, wherein the power control circuitry includes switches.

11. A method for securing mobile electronic devices and equipment including the steps of providing a substrate having circuitry for controlling power supplied to a portable electronic device wherein the substrate further includes an adhesive applied to a back side for attachment to a surface of the device and the face side includes the circuitry, which is wired onto a micro, printed, and then embedded into a groove etched on the face side; and affixing the substrate to the device, wherein removal of the substrate deactivates the power control circuitry so that the device is disabled without authorized user or supplier intervention.
